(19) United States
(12) Patent Application Publication
(10) Pub. No.: US 2020/0010076 A1
(43) Pub. Date: Jan. 9, 2020

(54) Driving Support Device

(71) Applicant: AISIN SEIKI KABUSHIKI KAISHA, Kariya-shi (JP)

(72) Inventors: Kinji Yamamoto, Anjo-shi (JP); Kazuya Watanabe, Anjo-shi (JP); Tetsuya Maruoka, Okazaki-shi (JP)

(73) Assignee: AISIN SEIKI KABUSHIKI KAISHA, Kariya-shi (JP)

(21) Appl. No.: 16/502,356

(22) Filed: Jul. 3, 2019

(30) Foreign Application Priority Data
Jul. 5, 2018 (JP) 2018-128333

(51) Int. Cl. B60W 30/06; B62D 15/02; B60R 1/00

(52) U.S. Cl. CPC B60W 30/06; B62D 15/0285; B60R 1/00; B60W 2420/42; B60R 2300/806; B60W 2710/20; B60W 2300/14

(57) ABSTRACT

A driving support device includes: a setting unit configured to set a target parking position; and a support unit configured to: steer, during forward movement of a towing vehicle, a steering unit to a side opposite to the target parking position in a left-right direction of the towing vehicle; then output steering information for steering the steering unit toward the target parking position; and output stop information for stopping the towing vehicle after a connection state between the towing vehicle and a towed vehicle which is towed by the towing vehicle is inclined toward the target parking position.

### CROSS REFERENCE TO RELATED APPLICATIONS

This application is based on and claims priority under 35 U.S.C. § 119 to Japanese Patent Application 2018-128333, filed on Jul. 5, 2018, the entire contents of which are incorporated herein by reference.

### TECHNICAL FIELD

This disclosure relates to a driving support device.

### BACKGROUND DISCUSSION

There is known a driving support device that supports parking of a vehicle. When a target parking position is set, the driving support device moves forward the vehicle to the side opposite to the target parking position and then moves backward the vehicle so as to make the vehicle travel to the target parking position. See, for example, U.S. Pat. No. 9,809,250B (Reference 1), JP5044136B (Reference 2), JP2009-269462A (Reference 3), and JP5737061B (Reference 4).

However, in the driving support device described above, it is difficult to properly park a towing vehicle that is towing a towed vehicle to the target parking position.

Thus, a need exists for a driving support device which is not susceptible to the drawback mentioned above.

### SUMMARY

A driving support device according to an aspect of this disclosure includes: a setting unit configured to set a target parking position; and a support unit configured to: steer, during forward movement of a towing vehicle, a steering unit to a side opposite to the target parking position in a left-right direction of the towing vehicle; then output steering information for steering the steering unit toward the target parking position; and output stop information for stopping the towing vehicle after a connection state between the towing vehicle and a towed vehicle which is towed by the towing vehicle is inclined toward the target parking position.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a plan view of a towing vehicle on which a driving support device according to an embodiment disclosed here is mounted and a towed vehicle;

FIG. 2 is a view illustrating the vicinity of a dashboard in a vehicle compartment of the towing vehicle of an embodiment disclosed here;

FIG. 3 is a block diagram illustrating an overall configuration of a driving support system including a driving support device of the embodiment disclosed here;

FIG. 4 is a functional block diagram for explaining the functions of the driving support device;

FIG. 5 is a view illustrating an exemplary display image including a setting image for setting a target parking direction in Embodiment 1;

FIG. 6 is a view illustrating an exemplary display image including a setting image in the state in which a target parking position is set;

FIG. 7 is a view illustrating an exemplary display image including a setting image in which a target parking direction is set in a depth line rotation mode;

FIG. 8 is a plan view illustrating driving support by a support unit;

FIG. 9 is a plan view illustrating driving support by the support unit at first steering;

FIG. 10 is a plan view illustrating driving support by the support unit at second steering;

FIG. 11 is a plan view illustrating driving support by the support unit at backward movement;

FIG. 12 is a flowchart of a driving support processing executed by the driving support device;

FIG. 13 is a flowchart of a setting processing of Embodiment 1 performed by the setting unit;

FIG. 14 is a flowchart of a support processing of Embodiment 1 executed by the support unit;

FIG. 15 is a view illustrating an exemplary display image including a setting image for setting a target parking position in Embodiment 2;

FIG. 16 is a view illustrating an exemplary display image including a setting image of a target parking direction in Embodiment 2;

FIG. 17 is a flowchart of a setting processing of Embodiment 2 performed by the setting unit;

FIG. 18 is a view illustrating an exemplary display image including a setting image in which a target parking direction is set in Embodiment 3;

FIG. 19 is a view illustrating an exemplary display image including a setting image in which a target parking direction is set in a frame rotation mode according to Embodiment 3;

FIG. 20 is a view illustrating an exemplary display image including a setting image in which a target parking direction is set in a depth line rotation mode according to Embodiment 3;

FIG. 21 is a flowchart of a setting processing of Embodiment 3 performed by the setting unit;

FIG. 22 is a view illustrating an exemplary setting image in an initial state in Embodiment 4;

FIG. 23 is a flowchart of a setting processing of Embodiment 4 performed by the setting unit;

FIG. 24 is a view illustrating an exemplary display image in which a target parking position is set in the setting processing of Embodiment 4;

FIG. 25 is a view illustrating an exemplary display image including a setting image in which a target parking direction is set in a frame rotation mode according to Embodiment 5;

FIG. 26 is a view illustrating an exemplary display image including a setting image in which a target parking direction is set in a depth line rotation mode according to Embodiment 5; and

FIG. 27 is a flowchart of a support processing of Embodiment 6 executed by the support unit.

### DETAILED DESCRIPTION

Hereinafter, the same components as those in the following exemplary embodiments and the like will be denoted by the same reference numerals, and redundant descriptions will be appropriately omitted.

### Embodiment 1

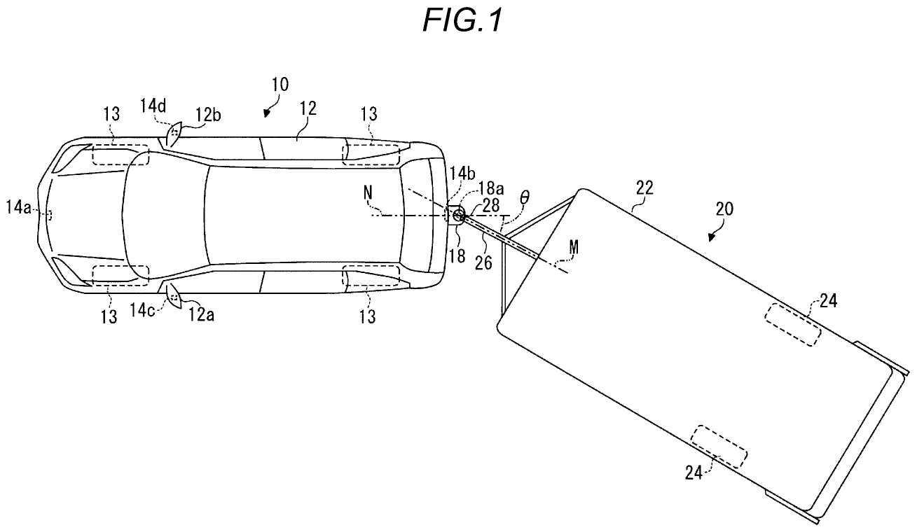

FIG. 1 is a plan view of a towing vehicle 10 on which a driving support device according to an embodiment disclosed here is mounted and a towed vehicle 20. The towing vehicle 10 is also referred to as a tractor, and is configured to be able to tow and travel the towed vehicle 20. The towing vehicle 10 may be an automobile (e.g., a hybrid automobile) having drive sources such as, for example, an internal combustion engine (e.g., an engine) and an electric motor (e.g., a motor). In addition, the towing vehicle 10 may be equipped with various transmissions, and may be equipped with various devices necessary for driving the internal combustion engine and the electric motor. In addition, for example, the system, the number, and the layout of the devices involved in driving wheels 13 in the towing vehicle 10 may be set variously.

As illustrated in FIG. 1, the towing vehicle 10 includes a vehicle body 12, four wheels 13, one or more (four in the present embodiment) imaging units 14a, 14b, 14c, 14d, and a towing apparatus 18. The imaging units 14a, 14b, 14c, 14d will be described as imaging units 14 when it is not necessary to distinguish the imaging units.

The vehicle body 12 constitutes a vehicle compartment in which occupants including a driver get on. The vehicle body 12 accommodates or holds, for example, the wheels 13 and the imaging unit 14 together with a driving support device described later.

The four wheels 13 are provided on the front, rear, left, and right of the vehicle body 12. For example, the two front wheels 13 function as steered wheels, and the two rear wheels 13 function as drive wheels.

The imaging units 14 are digital cameras each of which incorporates an imaging element such as, for example, a charge coupled device (CCD) or a CMOS image sensor (CIS). The imaging units 14 output moving image or still image data including a plurality of frame images generated at a predetermined frame rate as captured image data. Each of the imaging units 14 has a wide-angle lens or a fish-eye lens, and is able to capture an image in a range of 140° to 190° in the horizontal direction. The optical axis of each imaging unit 14 is set obliquely downward. Therefore, the imaging units 14 output data of a captured image obtained by imaging the periphery of the towing vehicle 10 including a road surface.

The imaging units 14 are provided around the vehicle body 12. For example, the imaging unit 14a is provided at the central portion of the front end of the vehicle body 12 in the left-right direction (e.g., a front bumper). The imaging unit 14a generates a captured image obtained by capturing an area around the front side of the towing vehicle 10. The imaging unit 14b is provided in the central portion of the rear end portion (e.g., a rear bumper) of the vehicle body 12 in the left-right direction. The imaging unit 14b generates a captured image obtained by capturing an area around the rear side of the towing vehicle 10. Specifically, the imaging unit 14b generates a captured image including a connecting member 26 to which the towed vehicle 20 is connected. The imaging unit 14c is provided in the central portion in the front-rear direction of the left end portion of the vehicle body 12 (e.g., the side mirror 12 a on the left side). The imaging unit 14c generates a captured image obtained by capturing an area around the left side of the towing vehicle 10. The imaging unit 14d is provided at a central portion in the front-rear direction of the right end portion of the vehicle body 12 (e.g., the side mirror 12b on the right side). The imaging unit 14d generates a captured image obtained by capturing an area around the right side of the towing vehicle 10.

A towing apparatus 18 is an apparatus called a hitch. The towing apparatus 18 is provided at the central portion of the vehicle body 12 in the left-right direction. The towing apparatus 18 protrudes rearward from the rear end of the vehicle body 12. The towing apparatus 18 has, for example, a spherical hitch ball 18a provided at the upper end of a columnar member erected in the vertical direction.

The towed vehicle 20 is also referred to as a trailer, and travels by being towed by the towing vehicle 10. The towed vehicle 20 includes a main body 22, a plurality of (two in the embodiment disclosed here) trailer wheels 24, a connecting member 26, and a coupler 28.

The main body 22 is formed, for example, in a rectangular box shape. The main body 22 is configured in a hollow shape so as to load, for example, luggage therein. In addition, the main body 22 may be a flat type having a plate shape.

The trailer wheels 24 are respectively provided on the left and right of the main body 22. The trailer wheels 24 are, for example, driven wheels. The trailer wheels 24 may be drive wheels connected to a drive source such as, for example, an engine or steered wheels capable of being steered in the left-right direction by, for example, a steering wheel.

The connecting member 26 is provided at the central portion of the main body 22 in the left-right direction. The connecting member 26 extends forward from the front end of the main body 22.

The coupler 28 is provided at the front end of the connecting member 26. The coupler 28 is formed with a spherical recess that covers the hitch ball 18a. The towed vehicle 20 is pivotably connected to the towing vehicle 10 by the coupler 28 covering the hitch ball 18a. In the embodiment disclosed here, an angle formed by the connection center axis N of the connecting member 26 and the vehicle center axis M of the towing vehicle 10 is referred to as a hitch angle θ. The hitch angle θ may be detected from captured image data captured by the imaging unit 24b, and thus a description thereof is omitted.

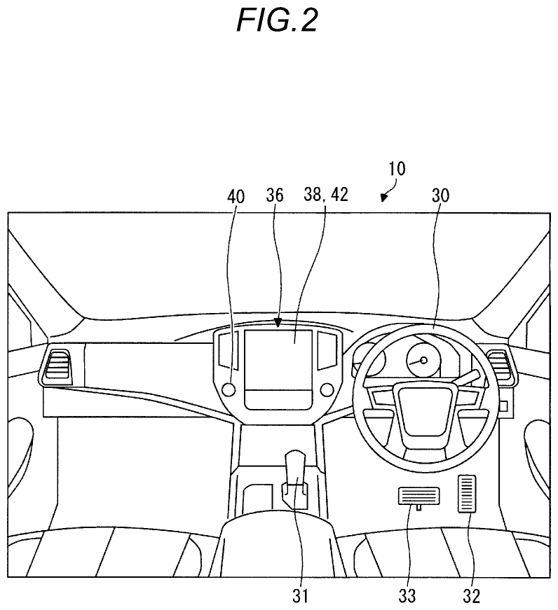

FIG. 2 is a view illustrating the vicinity of a dashboard in a vehicle compartment of the towing vehicle 10 of an embodiment disclosed here. As illustrated in FIG. 2, the towing vehicle 10 further includes a steering unit 30, a transmission unit 31, an acceleration unit 32, a braking unit 33, and a monitor device 36.

The steering unit 30 is a device operated by the driver in order to turn the front wheels 13 to change the leftward and rightward traveling directions of the towing vehicle 10. The steering unit 30 is, for example, a steering wheel or handle provided in front of the driver's seat so as to protrude from the center console.

The transmission unit 31 is a device that includes, for example, a shift lever protruding from the center console, and changes the transmission gear ratio of the towing vehicle 10 or the forward and backward traveling directions (e.g., drive, parking, and reverse) of the towing vehicle 10.

The acceleration unit 32 is a device operated by the driver in order to accelerate the towing vehicle 10. The acceleration unit 32 is, for example, an accelerator pedal installed under the driver's foot. The acceleration unit 32 receives an operation related to acceleration from the driver and accelerates the towing vehicle 10.

The braking unit 33 is a device operated by the driver in order to decelerate the towing vehicle 10. The braking unit 33 is, for example, a brake pedal installed under the driver's foot. The braking unit 33 receives an operation related to deceleration from the driver in order to decelerate the towing vehicle 10.

The monitor device 36 is provided on, for example, a dashboard in the vehicle compartment of the towing vehicle 10. The monitor device 36 has a display unit 38, a sound output unit 40, and an operation input unit 42.

The display unit 38 is, for example, a display device such as, for example, a liquid crystal display (LCD) or an organic electroluminescent (EL) display (OELD). The display unit 38 displays an image such as a road guide of a navigation system and a display image for driving support.

The sound output unit 40 is, for example, a speaker. The sound output unit 40 outputs, for example, sound that guides the driver in navigation.

The operation input unit 42 receives an input from an occupant. The operation input unit 42 is, for example, a touch panel. The operation input unit 42 is provided on the display screen of the display section 38. The operation input unit 42 is configured to be able to transmit an image displayed by the display unit 38. Thus, the operation input unit 42 is able to enable the occupant to visually recognize the image displayed on the display screen of the display unit 38. The operation input unit 42 receives an instruction input by the occupant touching the position corresponding to the image displayed on the display screen of the section 38. For example, the operation input unit 42 receives from the occupant an input of a target parking position of the towing vehicle 10 and a target parking direction which is the direction of the towing vehicle 10 at the target parking position. In addition, the operation input unit 42 is not limited to the touch panel, but may be a hard switch such as, for example, a push button-type switch.

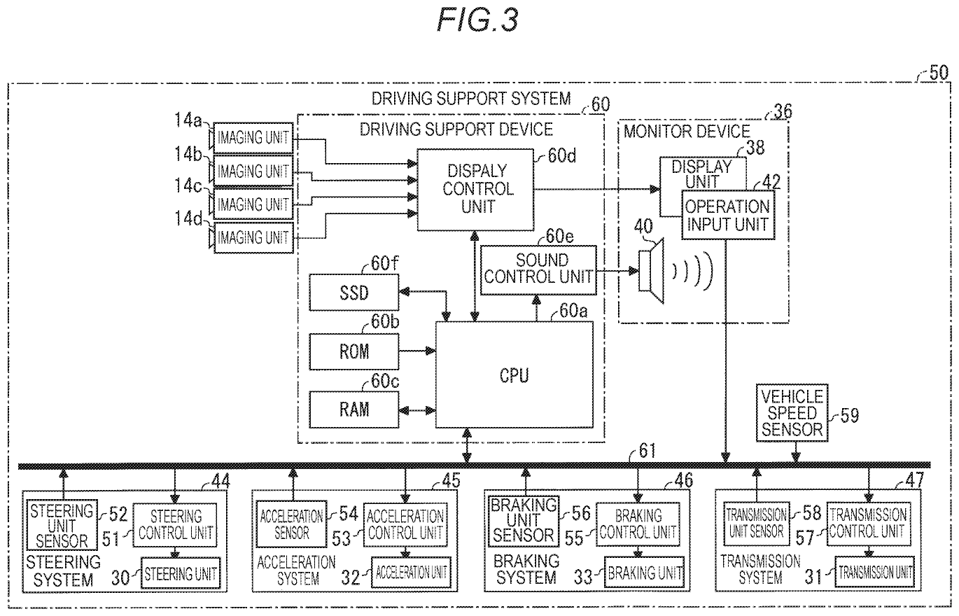

FIG. 3 is a block diagram illustrating the overall configuration of the operation support system 50 including the driving support device 60 of the embodiment. The driving support device 60 is mounted on the towing vehicle 10, and causes the display unit 38 to display a setting image for setting the target parking position and the target parking direction, including an image of the periphery of the towing vehicle 10 (hereinafter, referred to as a “peripheral image) and an image obtained by viewing the periphery from a virtual viewpoint above the periphery (hereinafter, referred to as a “bird's-eye-view image”). Based on the target parking position and the target parking direction set by the occupant on the setting image, the driving support device 60 supports the driving of the towing vehicle 10 that tows the towed vehicle 20. For example, the driving support device 60 moves forward the towing vehicle 10 that tows the towed vehicle 20 to the opposite side to the target parking position in the left-right direction, and then moves forward the towing vehicle 10 to the target parking position side. Thereafter, the driving support device 60 moves backward the towing vehicle 10 and parks towing vehicle 20 to the target parking position in the target parking direction.

As illustrated in FIG. 3, the driving support system 50 includes a plurality of imaging units 14a, 14b, 14c, 14d, a steering system 44, an acceleration system 45, a braking system 46, a transmission system 47, a vehicle speed sensor 59, a monitor device 36, a driving support device 60, and an in-vehicle network 61.

The plurality of imaging units 14 output the captured images obtained by capturing the peripheries of the towing vehicle 10 and the towed vehicle 20 to the driving support device 60.

The steering system 44 controls the leftward and rightward traveling directions of the towing vehicle 10. The steering system 44 has a steering unit 30, a steering control unit 51, and a steering unit sensor 52.

The steering control unit 51 is, for example, a computer including a microcomputer such as, for example, an electronic control unit (ECU) having a hardware processor such as, for example, a central processing unit (CPU). The steering control unit 51 controls the steering unit 30 and the traveling direction of the towing vehicle 10 based on an instruction from the driving support device 60.

The steering unit sensor 52 is, for example, an angle sensor including, for example, a hall element, and detects a steering angle, which is the rotation angle of the steering unit 30. The steering unit sensor 52 outputs the detected steering angle of the steering unit 30 to the in-vehicle network 61.

The acceleration system 45 controls the acceleration of the towing vehicle 10. The acceleration system 45 has an acceleration unit 32, an acceleration control unit 53, and an acceleration unit sensor 54.

The acceleration control unit 53 is, for example, a computer including a microcomputer such as, for example, an ECU having a hardware processor such as, for example, a CPU. The acceleration control unit 53 controls the acceleration unit 32 based on the instruction from the driving support device 60 so as to control the acceleration of the towing vehicle 10.

The acceleration unit sensor 54 is, for example, a position sensor, and detects the position of the acceleration unit 32 when the acceleration unit 32 is an accelerator pedal. The acceleration unit sensor 54 outputs the detected position of the acceleration unit 32 to the in-vehicle network 61.

The braking system 46 controls the deceleration of the towing vehicle 10. The braking system 46 has a braking unit 33, a braking control unit 55, and a braking unit sensor 56.

The braking control unit 55 is, for example, a computer including a microcomputer such as, for example, an ECU having a hardware processor such as, for example, a CPU. The braking control unit 55 controls the braking unit 33 based on an instruction from the driving support device 60 so as to control the deceleration of the towing vehicle 10.

The braking unit sensor 56 is, for example, a position sensor, and detects the position of the braking unit 33 when the braking unit 33 is a brake pedal. The braking unit sensor 56 outputs the detected position of the braking unit 33 to the in-vehicle network 61.

The transmission system 47 controls the transmission gear ratio of the towing vehicle 10. The transmission system 47 includes a transmission unit 31, a transmission control unit 57, and a transmission unit sensor 58.

The transmission control unit 57 is, for example, a computer including a microcomputer such as, for example, an ECU having a hardware processor such as, for example, a CPU. The transmission control unit 57 controls the transmission unit 31 based on an instruction from the driving support device 60 so as to control the transmission gear ratio of the towing vehicle 10.

The transmission unit sensor 58 is, for example, a position sensor, and detects the position of the transmission unit 31 when the transmission unit 31 is a shift lever. The transmission unit sensor 58 outputs the detected position of the transmission unit 31 to the in-vehicle network 61.

The vehicle speed sensor 59 detects, for example, vehicle speed information for calculating the vehicle speed that is the speed of the towing vehicle 10. The vehicle speed sensor 59 detects, for example, the number of revolutions of the output shaft of the transmission as vehicle speed information. In addition, the vehicle speed sensor 59 may detect the number of revolutions of the wheels 13, the number of revolutions of the output shaft of a drive unit such as, for example, an engine, as the vehicle speed information. The vehicle speed sensor 59 outputs the detected vehicle speed information to the in-vehicle network 61.

The driving support device 60 is a computer including a microcomputer such as, for example, an ECU. The driving support device 60 includes a CPU 60a, a read only memory (ROM) 60b, a random access memory (RAM) 60c, a display control unit 60d, a sound control unit 60e, and a solid state drive (SSD) 60f. The CPU 60a, the ROM 60b, and the RAM 60c may be integrated in the same package.

The CPU 60a is an example of a hardware processor, and reads a program stored in a non-volatile storage device such as, for example, the ROM 60b, and executes various arithmetic processings and control according to the program. The CPU 60a executes, for example, a processing for driving support of the towing vehicle 10.

The ROM 60b stores each program and parameters necessary for executing the program. The RAM 60c temporarily stores various data used in the arithmetic operation by the CPU 60a. The display control unit 60d mainly performs, for example, an image processing of a captured image obtained from the imaging units 14 and data conversion of a display image to be displayed on the display unit 38 during the arithmetic processing in the driving support device 60, and outputs the image information to the display unit 38. The sound control unit 60e mainly performs a processing of sound to be output to the sound output unit 40 during the arithmetic processing in the driving support device 60, and outputs sound data to the sound output unit 40. The SSD 60f is a rewritable non-volatile storage device, and maintains data even when the driving support device 60 is powered off.

The in-vehicle network 61 includes, for example, a controller area network (CAN) and a local interconnect network (LIN). The in-vehicle network 61 interconnects the sensors 52, 54, 56, 58, 59, the control units 51, 53, 55, 57, the operation input unit 42 of the monitor device 36, and the driving support device 60 so as to be capable of transmitting and receiving information to and from each other.

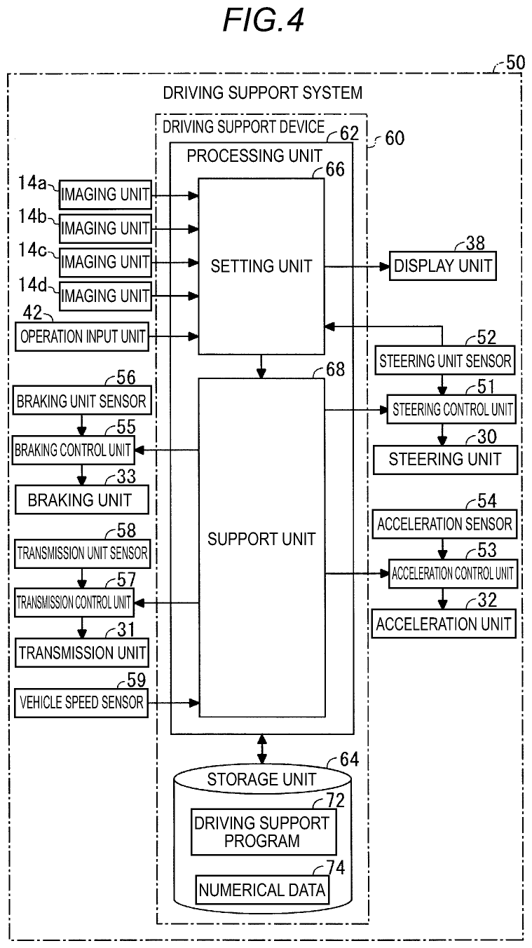

FIG. 4 is a functional block diagram illustrating the functions of the driving support device. As illustrated in FIG. 4, the driving support device 60 has functions of a processing unit 62 and a storage unit 64.

The processing unit 62 is implemented as a function of the CPU 60a. The processing unit 62 implements at least some of the functions as the driving support device 60 as hardware and software (a driving support program 72) cooperate with each other. The processing unit 62 has the functions of a setting unit 66 and a support unit 68. The processing unit 62 may implement the functions of the setting unit 66 and the support unit 68 by reading the driving support program 72 stored in the storage unit 64. A part or all of the setting unit 66 and the support unit 68 may be configured by hardware such as, for example, a circuit including an application specific integrated circuit (ASIC) and a field-programmable gate array (FPGA).

The setting unit 66 sets a target parking position and a target parking direction in which the towing vehicle 10 and the towed vehicle 20 are parked. The setting unit 66 may set the target parking position at a predetermined relative position with respect to the towing vehicle 10 according to an instruction from the occupant. The setting unit 66 may set the target parking direction as the direction of the towing vehicle 10 at the target parking position. For example, in the state in which a setting image including a target parking frame for setting the target parking position is displayed on the display unit 38, the setting unit 66 may receive the inclination of the target parking frame and set the target parking direction based on the received inclination. Specifically, the setting unit 66 may set, as the target parking direction, the inclination of the target parking frame obtained by rotating the target parking frame on the setting screen depending on the steering of the steering unit 30. The setting unit 66 may rotate and tilt the target parking frame depending on the steering angle of the steering unit 30, which is acquired from the steering unit sensor 52. The setting unit 66 outputs, to the support unit 68, target parking information including the set target parking position and target parking direction.

The support unit 68 controls each system 44, 45, 46, 47 based on, for example, a sensor value acquired from each sensor 52, 54, 56, 58, 59, and parks the towing vehicle 10 and the towed vehicle 20 based on the target parking position and the target parking direction included in target parking information output from the setting unit 66. Specifically, when acquiring the target parking information from the setting unit 66, the support unit 68 outputs an acceleration instruction to the acceleration control unit 53 so as to control the acceleration unit 32 to move forward the towing vehicle 10. The support unit 68 controls the steering unit 30 while the towing vehicle 10 is moving forward. Specifically, the support unit 68 outputs steering information indicating a steering angle to the steering control unit 51 during the forward movement, and steers the steering unit 30 to the opposite side to the target parking position, and then to the target parking position side. The support unit 68 may switch the steering of the steering unit 30 from the side opposite to the target parking position to the target parking position based on, for example, the distance between the towing vehicle 10 and the target parking position and the direction to the target parking position. The support unit 68 may output stop information for stopping the towing vehicle 10 after the connection state between the towing vehicle 10 and the towed vehicle 20 is inclined toward the target parking position. For example, the support unit 68 may output stop information depending on a hitch angle to switch the towing vehicle 10 from forward movement to backward movement. In addition, the support unit 68 may stop the towing vehicle 10 by outputting stop information for stopping the towing vehicle 10 after the rear end portion of the towed vehicle 20 advances from the target parking position existing on the left or right side of the towed vehicle 20. Specifically, when the hitch angle reaches a predetermined determination angle, the support unit 68 controls the braking unit 33 and the acceleration unit 32 to stop the towing vehicle 10. The support unit 68 may determine whether the hitch angle reaches the determination angle based on the hitch angle calculated from the captured image of the imaging unit 14b. The support unit 68 controls the acceleration unit 32 and the transmission unit 31 to move backward the stopped towing vehicle 10. The support unit 68 steers the steering unit 30 to park the towing vehicle 10 and the towed vehicle 20 at the target parking position in the target parking direction. In the embodiment disclosed here, when it is determined that parking at the target parking position is possible based on the hitch angle, any determination method may be used as long as the towing vehicle 10 can be stopped. For example, it is conceivable that the support unit 68 constantly calculates a moving trajectory when neutral steering or predetermined reverse steering is performed based on the current hitch angle and the current positions of the towing vehicle 10 and the towed vehicle 20 after performing the second stage steering and stops the towing vehicle 10 at a time when it is determined that it is possible to stop the towing vehicle 10 at the target parking position. In this way, the support unit 68 of the embodiment disclosed here is set to perform a control to stop the towing vehicle 10 after performing two-step steering in which the steering unit 30 is steered to a side opposite to the target parking position while the towing vehicle 10 is moving forward and then the steering unit 30 is steered to the target parking position side. With the steering to the side opposite to the target parking position in the first step, the towing vehicle 10 and the towed vehicle 20 may be made to be left at a distance from the target parking position, with the steering to the target parking position in the second step, the towed vehicle 20 may made to take an orientation inclined toward the target parking position with respect to the towing vehicle 10. Thus, the embodiment disclosed here is capable of implementing the movement of the towing vehicle 10 and the towed vehicle 20 to a position where the towing vehicle 10 and the towed vehicle 20 is parkable at the target parking position and the securement of a parkable orientation.

The storage unit 64 is implemented, for example, as a function of at least one of the ROM 60b, the RAM 60c, and the SSD 60f. The storage unit 64 is connected to the processing unit 62 so as to be able to input and output information. The storage unit 64 may be an external storage device connected via, for example, a network. The storage unit 64 stores, for example, a program executed by the processing unit 62 and data necessary for executing the program. For example, the storage unit 64 stores a driving support program 72 to be executed by the processing unit 62. In addition, the driving support program 72 may be provided by being stored in a computer-readable storage medium such as, for example, a compact disc read only memory (CD-ROM) or a digital versatile disc read only memory (DVD-ROM), or may be provided via a network such as, for example, the Internet. The storage unit 64 stores numerical data 74 necessary for the execution of the driving support program 72. The numerical data 74 may include, for example, a determination angle. The storage unit 64 temporarily stores, for example, target parking information and image data, for example, such as a captured image.

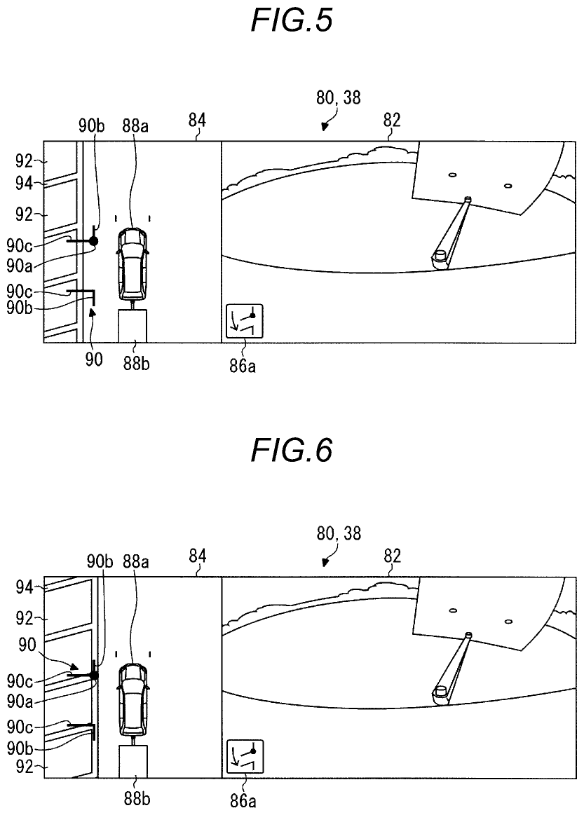

FIG. 5 is a view illustrating an exemplary display image 80 including a setting image 84 for setting a target parking direction in Embodiment 1. As illustrated in FIG. 5, the setting unit 66 causes the display unit 38a to display the display image 80 including a peripheral image 82 and a setting image 84, and receives an input of a target parking position and a target parking direction. The setting unit 66 arranges the peripheral image 82 on the right side and the setting image 84 on the left side in the display image 80. The arrangement of the peripheral image 82 and the setting image 84 may be appropriately changed.

The setting unit 66 causes the display unit 38 to display, for example, a captured image of the imaging unit 14 b installed on the rear portion of the towing vehicle 1 as the peripheral image 82. The setting unit 66 may cause the display unit 38 to display a captured image of another imaging unit 14 as the peripheral image 82. For example, the setting unit 66 may adopt the captured image of the imaging unit 14 on the target parking position side as the peripheral image 82. The setting unit 66 may superimpose a depth line rotation mode button 86a that receives an instruction of the depth line rotation mode, which is a mode for setting a target parking direction, on the peripheral image 82.

The setting unit 66 causes the display unit 38 to display the setting image 84 including, for example, bird's-eye-view images overhead images generated from captured images of the four imaging units 14 provided on the front, rear, left, and right of the towing vehicle 10. The setting unit 66 may superimpose a vehicle image 88a and a vehicle image 88b indicating the positions of the towing vehicle 10 and the towed vehicle 20 on the setting image 84. The setting unit 66 may superimpose a target parking frame 90 including a reference point 90a on the setting image 84. The setting unit 66 may set the position of the target parking frame 90 in the left-right direction (here, the left side) depending on, for example, an input from the occupant. The target parking frame 90 includes a pair of direction lines 90b and a pair of depth lines 90c. The pair of direction lines 90b extend along the traveling direction of the towing vehicle 10, and are arranged at an interval of about the width of the towing vehicle 10. The pair of depth lines 90c extend from the inner end points of the corresponding direction lines 90b to the deep side (here, the left side) of the target parking frame 90, and are parallel to and face each other. The depth lines 90c may intersect (e.g., be orthogonal to) the directional lines 90b. The setting unit 66 may arrange the target parking frame 90 at a predetermined position from the vehicle image 88a of the towing vehicle 10. The bird's-eye-view image in the setting image 84 includes division lines 94 provided on the road surface in order to divide the parking frame 92 of the parking lot. The depth lines of the division lines 94 are inclined along the passage of the parking lot. Specifically, in the depth lines of the dividing lines 94, the entrance side is disposed closer to the traveling direction of the towing vehicle 10 than the deep side.

FIG. 6 is a view illustrating an exemplary display image including a setting image 84 in the state in which a target parking position is set. As illustrated in FIG. 6, when the towing vehicle 10 moves forward, the setting unit 66 causes the bird's-eye-view image in the setting image 84 to move backward with respect to the vehicle images 88a and 88b. The driver moves the towing vehicle 10 such that the reference point 90a of the target parking frame 90 is aligned with a corner of the division line 94. When the occupant operates the depth line rotation mode button 86 a by touch, the setting unit 66 fixes the reference point 90a of the target parking frame 90 on the setting image 84, sets the target parking position according to the reference point 90a of the target parking frame 90, and shifts to the depth line rotation mode.

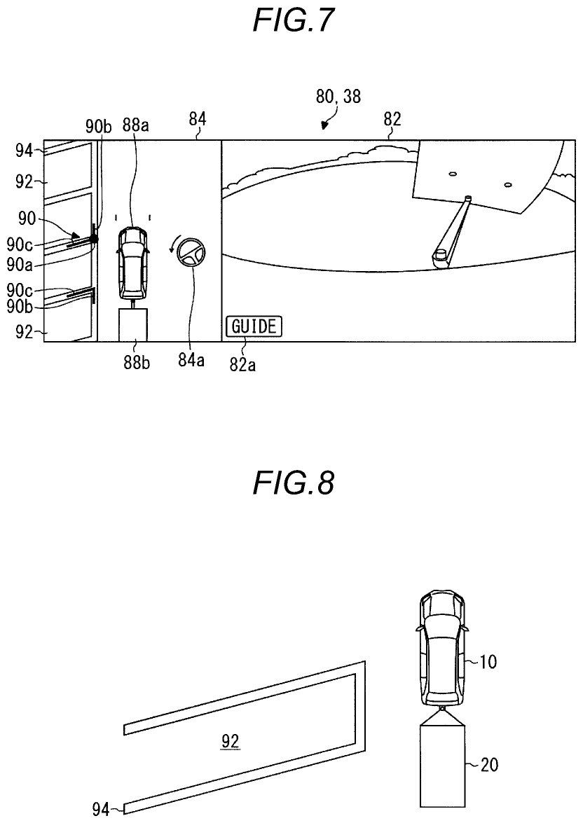

FIG. 7 is a view illustrating an exemplary display image 80 including a setting image 84 in which a target parking direction is set in a depth line rotation mode. As illustrated in FIG. 7, in the depth line rotation mode, the setting unit 66 receives turning of the steering unit 30 and turns the depth lines 90c while superimposing the guide button 82a instructing driving support on the peripheral image 82. Specifically, when the driver turns the steering unit 30, the setting unit 66 acquires the steering angle of the steering unit 30 from the steering unit sensor 52. The setting unit 66 turns a pair of depth lines 90c while fixing the direction lines 90b depending on the steering angle of the steering unit 30. The steering angle referred to here is, for example, a rotation angle from a reference angle, assuming that the position of the steering unit 30 when shifting to the depth line rotation mode is the reference angle (i.e., 0°). The setting unit 66 rotates the depth lines 90c on the setting image 84 about respective ends of the pair of depth lines 90c (here, the ends on the direction line 90b side) as the center of rotation. Here, the setting unit 66 may superimpose the steering image 84a indicating, for example, the rotation direction of the steering unit 30 on the setting image 84. The driver operates the guide button 82a by touch while aligning the depth lines 90c with the dividing lines 94 while looking at the depth lines 90c that rotates in response to the steering of the steering unit 30. When receiving a support instruction by the operation of guide button 82a, the setting unit 66 sets a target parking direction depending on the depth lines 90c, and outputs target parking information including the target parking position and the target parking direction to support unit 68.

FIG. 8 is a plan view illustrating driving support by the support unit 68. As illustrated in FIG. 8, it is assumed that the towing vehicle 10 is positioned in the vicinity of the division lines 94 of the parking frame 92, which are the target of the target parking position and the target parking direction when the support unit 68 receives the support instruction.

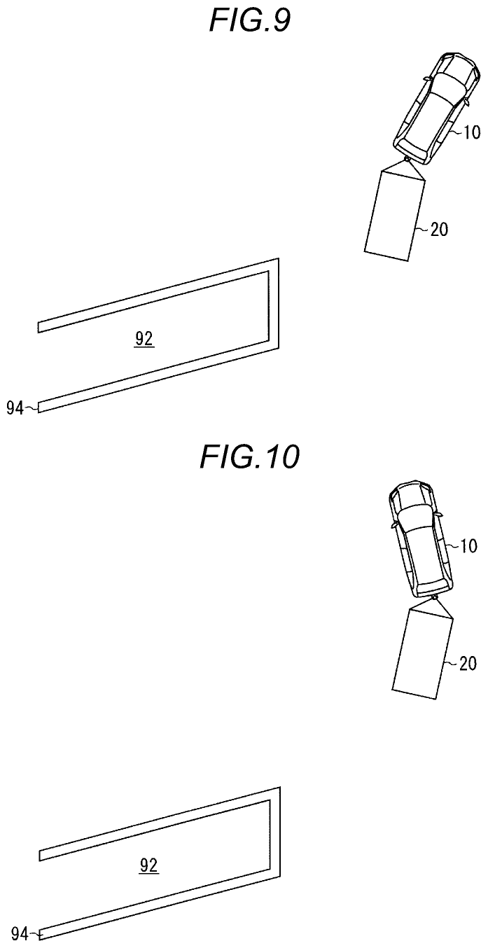

FIG. 9 is a plan view illustrating driving support by the support unit 68 at the first steering. As illustrated in FIG. 9, when starting starts driving support, the support unit 68 controls the acceleration unit 32 to move the towing vehicle 10 forward, and steers the steering unit 30 to a side opposite to the target parking position (here, right side) so as to make the towing vehicle 10 move forward to the side opposite to the target parking position.

FIG. 10 is a plan view illustrating driving support by the support unit 68 at the second steering. As illustrated in FIG. 10, for example, when the distance from the target parking position becomes a predetermined distance, the support unit 68 steers the steering unit 30 toward the target parking position while continuing the forward movement, thereby making the towing vehicle 10 move to the target parking position side. Thus, the support unit 68 is capable of bending the towing vehicle 10 and the towed vehicle 20 so as to protrude to the side opposite to the target parking position. When the hitch angle reaches a predetermined determination angle, the support unit 68 controls the braking unit 32 and the acceleration unit 33 to stop the towing vehicle 10. The hitch angle for stopping the towing vehicle 10 in FIG. 10 is determined to correspond to the target parking direction. In other words, when the target parking direction is set by the setting unit 66, the support unit 68 of the embodiment disclosed here outputs stop information for stopping the towing vehicle 10 when the hitch angle corresponding to the target parking direction is reached.

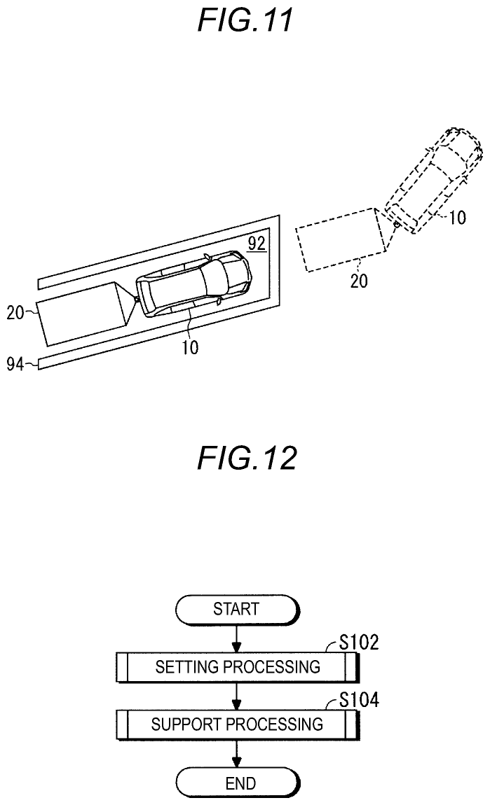

FIG. 11 is a plan view illustrating driving support by the support unit 68 at backward movement. As illustrated in FIG. 11, the support unit 68 stops the towing vehicle 10 having the hitch angle, and then steers the steering unit 30 to the reference state (so-called a neutral state) or the target parking position side while moving backward the towing vehicle 10 by controlling the acceleration unit 32 and the transmission unit 31, so that the towing vehicle 10 and the towed vehicle 20 are guided to the target parking frame 92 so as to be in the target parking position and the target parking direction. When the towing vehicle 10 and the towed vehicle 20 reach the parking frame 92, the support unit 68 controls the acceleration unit 32 and the braking unit 33 to stop the towing vehicle 10.

FIG. 12 is a flowchart of a driving support processing executed by the driving support device 60. As illustrated in FIG. 12, in the driving support processing, the setting unit 66 executes the setting processing to set the target parking position and the target parking direction, and outputs the target parking information including the target parking position and the target parking direction to the support part 68 (S102). When acquiring the target parking information, the support unit 68 executes the support processing to support the driving of the towing vehicle 10 so that the target parking direction is obtained at the target parking position (S104).

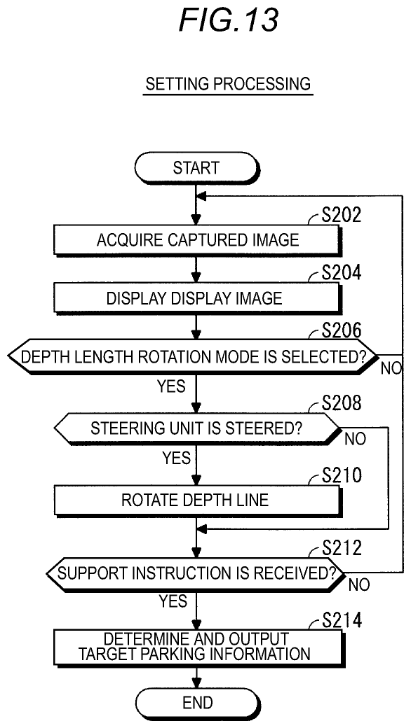

FIG. 13 is a flowchart of a setting processing of Embodiment 1 performed by the setting unit 60. As illustrated in FIG. 13, in the setting processing of Embodiment 1, the setting unit 66 acquires captured images from the imaging units 14 (S202), and causes the display unit 38 to display the setting image 84 including the target parking frame 90 and the display image 80 including the peripheral image 84 as illustrated in FIG. 5 (S204). In this state, the driver moves the towing vehicle 10 to align the target parking frame 90 with the corner of the division lines 94 on the road surface.

The setting unit 66 determines whether the occupant has selected the depth line rotation mode (S206). The setting unit 66 repeats step S202 and subsequent steps until the occupant selects the depth line rotation mode (S206: No). As illustrated in FIG. 6, when the driver aligns the target parking frame 90 with a corner of the division lines 94 on the road surface and operates the depth line rotation mode button 86a, the setting unit 66 determines that the depth line rotation mode has been selected (S206: Yes), and determines whether the occupant has steered the steering unit 30 (S208). The setting unit 66 also executes step S208 even when the depth line rotation mode has already been selected. When it is determined that the steering unit 30 has not been steered (S208: No), the setting unit 65 executes step S212.

When it is determined that the steering unit 30 has been steered (S208: Yes), as shown in FIG. 7, the setting unit 66 rotates the pair of depth lines 90c of the target parking frame 90 on the display image 80 about the ends of the depth lines 90c as respective rotation centers (S210). The setting unit 66 determines whether a support instruction has been acquired (S212). When it is determined that the support instruction has not been acquired (S212: No), the setting unit 66 repeats step S202 and subsequent steps. When the occupant touches and operates the guide button 82a, the setting unit 66 determines that a support instruction has been acquired (S212: Yes), determines the target parking position and the target parking direction, and outputs the target parking information including the target parking position and the target parking direction to the support unit 68 (S214). Thus, the setting unit 66 terminates the setting processing.

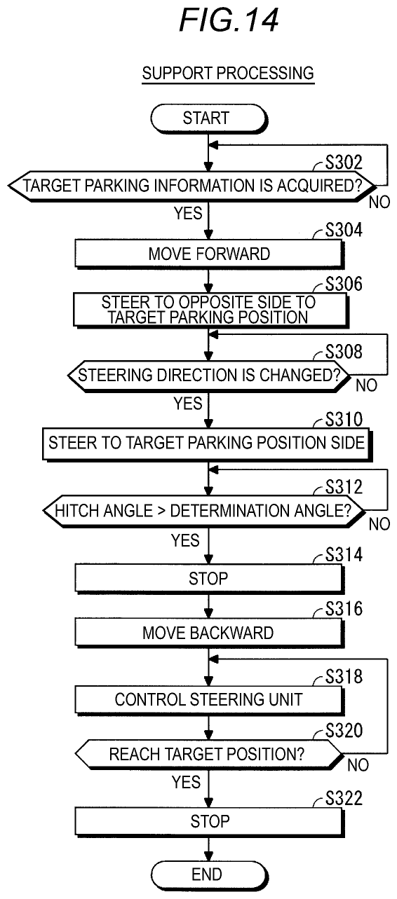

FIG. 14 is a flowchart of a support processing of Embodiment 1 performed by the support unit 68. As illustrated in FIG. 14, the support unit 68 determines whether the target parking information has been acquired from the setting unit 66 (S302). The support unit 68 is in a standby state until the target parking information is acquired (S302: No). When acquiring the target parking information (S302: Yes), the support unit 68 controls the acceleration unit 32 from the state illustrated in FIG. 8 via the acceleration control unit 53 to move the towing vehicle 10 forward (S304). The support unit 68 controls the steering unit 30 to perform steering to the side opposite to the target parking position by outputting steering information indicating the steering angle to the steering control unit 51 when the forward movement is started (S306). Thus, the towing vehicle 10 moves forward to the side opposite to the target parking position, as illustrated in FIG. 9.

The support unit 68 determines whether to change the steering direction (S308). The support unit 68 continues forward movement and steering in the same direction until it is determined that the steering direction is to be changed (S308: No). When it is determined that the steering direction is to be changed based on the distance from the target parking position to the towing vehicle 10 (S308: Yes), the support unit 68 steers the steering unit 30 to the target parking position side (S310), as illustrated in FIG. 10, by outputting steering information indicating the steering angle to the steering control unit 51 while continuing the forward movement.

The support unit 68 determines whether the hitch angle is larger than the determination angle (S312). The support unit 68 continues the forward movement and steering until the hitch angle becomes larger than the determination angle (S312: No). When it is determined that the hitch angle become larger than the determination angle (S312: Yes), the support unit 68 terminates the control of the acceleration unit 32, and controls the braking unit 33 via the braking control unit 55 to stop the towing vehicle 10 (S314). The support unit 68 causes the transmission control unit 57 to control the transmission unit 31 to switch the transmission unit 31 to reverse, and controls the acceleration unit 32 via the acceleration control unit 53 to move the towing vehicle 10 backward (S316). The support unit 68 controls the steering unit 30 via the steering control unit 51 such that the towing vehicle 10 is in the target parking direction at the target parking position with the start of the backward movement (S318). For example, the support unit 68 may steer the steering unit 30 to the reference state or the target parking position side.

The support unit 68 determines whether the towing vehicle 10 reaches the target parking position (S320). The support unit 68 controls the steering unit 30 while continuing the backward movement until the towing vehicle 10 reaches the target parking position (S320: No).

When it is determined that the towing vehicle 10 reaches the target parking position as illustrated in FIG. 11 (S320: Yes), the support unit 68 controls the braking unit 33 to stop the towing vehicle 10 (S322). Thus, the support unit 68 terminates the support processing.

As described above, in driving support of the driving vehicle 10 which is towing the towed vehicle 20 to the target parking position of the towing vehicle 10, the driving support device 60 performs steering to the side opposite to the target parking position at the time of forward movement and then performs steering to the target parking position side. Thus, since the driving support device 60 moves backward the towing vehicle 10 to the target parking position after bending and protruding the towing vehicle 10 and the towed vehicle 20 to the side opposite to the target parking position in a plan view while separating the towing vehicle 10 by a predetermined distance from the target parking position, it is possible to appropriately park the towing vehicle 10 and the towed vehicle 20 even if the space around the target parking position is a narrow space.

For example, in the case where only the forward control of the towing vehicle 10 and the towed vehicle 20 is performed without performing the two-step control, the towing vehicle 10 and the towed vehicle 20 are not in a state of being separated to some extent from the target parking position. Thus, it is necessary to carefully control the inner wheels so as not to collide with an object existing outside the target parking area. As another example, when the towing vehicle 10 is steered only to the side opposite to the target parking position while moving forward and then moves backward to be parked at the target parking position, the towing vehicle 10 is in the state of being separated to some extent from the target parking position. However, since the towing vehicle 10 and the towed vehicle 20 are in the state of being bent to the side opposite to the target parking position, a large space is required for the forward movement by the towing vehicle 10 for canceling the state in which the towing vehicle 10 and the towed vehicle 20 are bent to the side opposite to the target parking position. In addition, even if the towing vehicle 10 is steered only to the side opposite to the target parking position and then the towing vehicle 10 neutrally moves forward and then backward to be parked at the target parking position, a large space is required for the towing vehicle 10 to move forward as well. Furthermore, when the towing vehicle 10 is steered only to the target parking position side at the time of forward movement and then moves backward to be parked at the target parking position, a large space is required on the target parking position side for the towing vehicle 10 to move forward. Meanwhile, since the driving support device 60 performs steering in two steps as described above, the towing vehicle 10 and the towed vehicle 20 are protruded and bent to the side opposite the target parking position at a constant distance from the target parking position. Thus, the driving support device 60 is capable of appropriately parking the towing vehicle 10 and the towed vehicle 20 even in a small space.

The driving support device 60 is capable of appropriately parking the towing vehicle 10 and the towed vehicle 20 while reducing the driver's work by outputting the steering angle and controlling the steering unit 30 via the steering control unit 51.

Since the driving support device 60 determines whether to switch from forward movement to backward movement depending on the hitch angle, it is possible to appropriately bend the towing vehicle 10 and the towed vehicle 20 and then to start the backward movement. Thus, the driving support device 60 is capable of parking the towing vehicle 10 and the towed vehicle 20 more appropriately.

The driving support device 60 sets the target parking direction depending on the inclination of the target parking frame 90 acquired in the state of causing the display unit 38 to display the target parking frame 90. Thus, the driving support device 60 is capable of adjusting the target parking direction by making the occupant visually recognize the relationship between the target parking direction and the towing vehicle 10 or the target parking frame 90 for the frame line on the road surface.

The driving support device 60 causes the driver to adjust the target parking direction through the steering of the steering unit 30. Thus, the driving support device 60 may enable the occupant to finely adjust the target parking direction in an intuitively easy-to-understand manner. In addition, by setting the position of the steering unit 30 at the time of shifting to the depth line rotation mode as the reference state, the driving support device 60 is capable of immediately receiving the setting of the target parking position after shifting to the depth line rotation mode.

The driving support device 60 adjusts the target parking direction by rotating the pair of depth lines 90c of the target parking frame 90 on the display image 80 about the ends of the depth lines 90c as respective rotation centers. Thus, even if the parking frame 92 is inclined with respect to the road of a parking lot, the driving support device 60 is capable of appropriately setting the target parking direction and parking the towing vehicle 10 according to the parking frame 92.

Since the driving support device 60 outputs stop information for stopping the towing vehicle 10 when the hitch angle corresponding to the target parking direction is reached, the driving support device 60 is capable of appropriately stopping the towing vehicle 10 to correspond to the target parking direction.

Since the driving support device 60 outputs the stop information for stopping the towing vehicle 10 after the rear end portion of the towing vehicle 20 advances from the target parking position existing on the left or right side of the towed vehicle 20, the driving support apparatus is capable of stopping the towing vehicle 10 at an appropriate position corresponding to the parking position. In addition, the stop information may be information for instructing the braking unit 33 to perform braking, or may be at least one of display image data and sound data for prompting the driver to stop.

### Embodiment 2

Embodiment 2 in which the setting method of the target parking direction on the setting image 84 is different will be described.

The setting unit 66 of Embodiment 2 sets the target parking direction by rotating the entire target parking frame 90 about first coordinates present on the setting image 84 by the operation of the steering unit 30 of the driver.

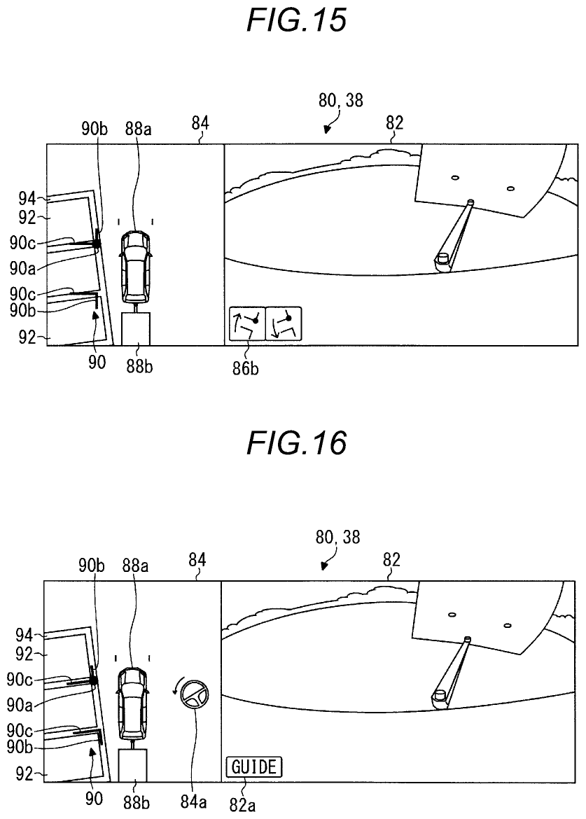

FIG. 15 is a view illustrating an exemplary display image 80 including a setting image 84 for setting a target parking position in Embodiment 2. As illustrated in FIG. 15, the occupant operates a frame rotation mode button 86b for receiving an instruction of the frame rotation mode which is a mode for aligning the reference point 90a of the target parking frame 90 with a corner of the division lines 94 and setting the target parking direction. Thus, the setting unit 66 starts to receive the steering angle of the steering unit 30 for setting the target parking direction.

FIG. 16 is a view illustrating an exemplary display image 80 including a setting image 84 for setting a target parking direction in Embodiment 2. As illustrated in FIG. 16, when acquiring the steering angle of the steering unit 30 from the steering unit sensor 52 in the frame rotation mode, the setting unit 66 rotates the target parking frame 90 depending on the steering angle. The steering angle referred to here is, for example, a rotation angle from a reference angle, assuming that the position of the steering unit 30 when shifting to the frame rotation mode is the reference angle (i.e.,0°). Specifically, the setting unit 66 sets the reference point 90a as a first coordinate, and rotates the entire target parking frame 90 about the first coordinate depending on the steering angle of the steering unit 30. In other words, the setting unit 66 rotates the target parking frame 90 while maintaining the angle between the direction line 90b and the depth line 90c. The setting unit 66 sets the target parking direction depending on the direction of the target parking frame 90. When the guide button 82a is operated by the occupant, the setting unit 66 sets the target parking position and the target parking direction, and outputs target parking information including the target parking position and the target parking direction to the support unit 68.

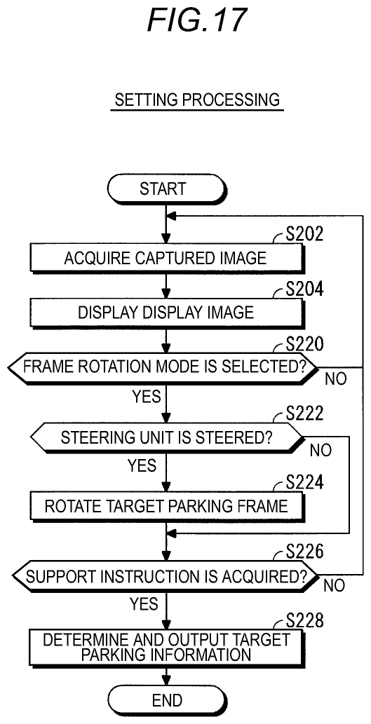

FIG. 17 is a flowchart of a setting processing of Embodiment 2 performed by the setting unit 60. The steps of the same contents as the steps of the setting processing of Embodiment 1 will be given the same step numbers and a description thereof will omitted.

As illustrated in FIG. 17, in the setting processing of Embodiment 2, the setting unit 66 executes steps S202 to S204. The setting unit 66 determines whether the occupant has selected the depth line rotation mode (S220). The setting unit 66 repeats step S202 and subsequent steps until the occupant selects the frame rotation mode (S220: No). As illustrated in FIG. 15, when the driver aligns the target parking frame 90 with a corner of the division lines 94 on the road surface and operates the frame rotation mode button 86b, the setting unit 66 determines that the frame rotation mode has been selected (S220: Yes), and determines whether the occupant has steered the steering unit 30 (S222). In addition, the setting unit 66 also executes step S208 even when the frame rotation mode has already been selected. When it is determined that the steering unit 30 has not been steered (S222: No), the setting unit 65 executes step S226.

When it is determined that the steering unit 30 has been steered (S222: Yes), as shown in FIG. 16, the setting unit 66 rotates, depending on the steering angle of the steering unit 30, the entire target parking frame 90 around reference point 90a which is the rotation center (S224). The setting unit 66 determines whether a support instruction has been acquired (S226). When it is determined that the support instruction has not been acquired (S226: No), the setting unit 66 repeats step S202 and subsequent steps. When the occupant operates the guide button 82a, the setting unit 66 determines that a support instruction has been acquired (S226: Yes), determines the target parking position and the target parking direction, and outputs the target parking information including the target parking position and the target parking direction to the support unit 68 (S228). Thus, the setting unit 66 terminates the setting processing.

As described above, the driving support device 60 of Embodiment 2 adjusts the target parking direction by rotating the entire target parking frame 90 on the display image 80 about the first coordinate. As a result, the driving support device 60 is capable of appropriately setting the direction of the target parking frame 90 with respect to the towing vehicle 10.

### Embodiment 3

Embodiment 3 in which the setting processing of Embodiment 1 and the setting processing of Embodiment 2 are combined will be described.

The setting unit 66 in Embodiment 3 executes a depth line rotation mode in which a target parking direction is set by rotating the depth line 90c, and a frame rotation mode in which a target parking direction is set by rotating the entire target parking frame 90. The setting unit 66 may execute the depth line rotation mode and the frame rotation mode in response to the selection of the occupant.

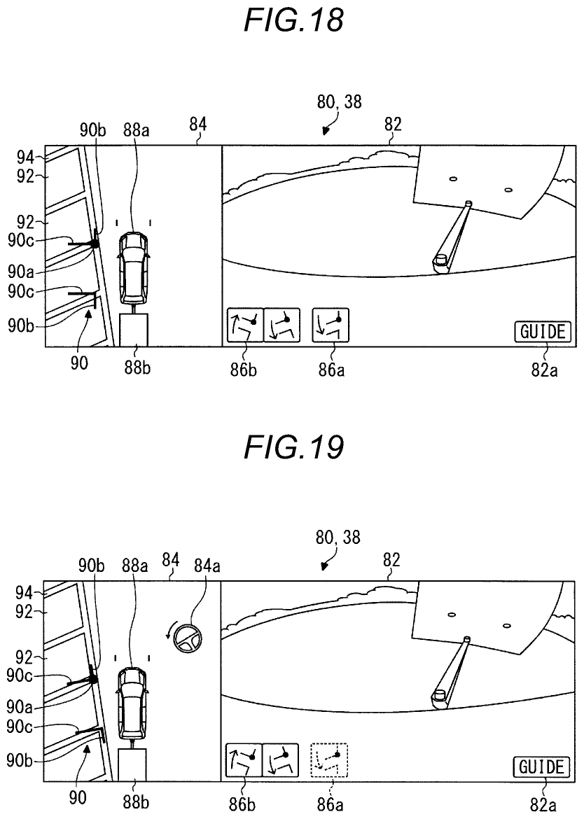

FIG. 18 is a view illustrating an exemplary display image 80 including a setting image 84 in which a target parking position is set in Embodiment 3. As illustrated in FIG. 18, in Embodiment 3, the setting unit 66 superimposes the depth line rotation mode button 86a and the frame rotation mode button 86b on the setting image 84. The driver drives the towing vehicle 10 to align the reference point 90a of the target parking frame 90 with a corner of the division lines 94. In this state, the occupant selects and operates either the depth line rotation mode button 86a or the frame rotation mode button 86b.

FIG. 19 is a view illustrating an exemplary display image 80 including a setting image 84 in which a target parking direction is set in a frame rotation mode according to Embodiment 3. When the driver operates the frame rotation mode button 86b and then steers the steering unit 30, as illustrated in FIG. 19, the setting unit 66 rotates the entire target parking frame 90 around the reference point 90a depending on the steering angle of the steering unit 30 which is acquired from the steering unit sensor 52. In addition, the setting unit 66 may change the display of the depth line rotation mode button 86a in the frame rotation mode. For example, the setting unit 66 may change the display of the depth line rotation mode button 86a to be translucent in the frame rotation mode.

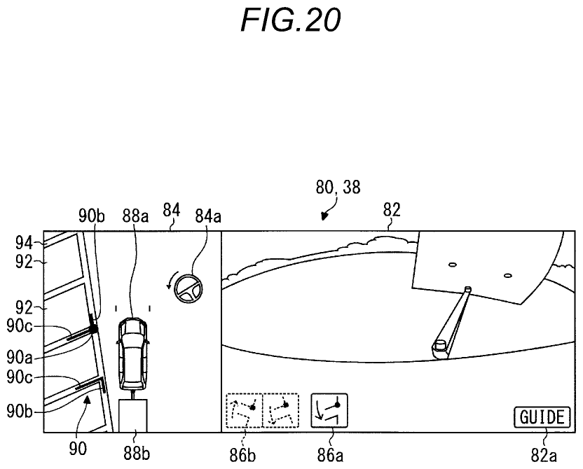

FIG. 20 is a view illustrating an exemplary display image 80 including a setting image 84 in which a target parking direction is set in a depth line rotation mode according to Embodiment 3. When the driver operates the depth line rotation mode button 86a and then steers the steering unit 30, as illustrated in FIG. 20, the setting unit 66 rotates a pair of depth lines 90c around respective ends of the depth lines 90c depending on the steering angle of the steering unit 30 which is acquired from the steering unit sensor 52. In addition, the setting unit 66 may change the display of the frame rotation mode button 86b in the depth line rotation mode. For example, the setting unit 66 may change the display of the frame rotation mode button 86b to be translucent in the depth line rotation mode.

FIG. 21 is a flowchart of a setting processing of Embodiment 3 performed by the setting unit 60. The steps of the same contents as the steps of the setting processing of the embodiments described above will be given the same step numbers and a description thereof will omitted.

As illustrated in FIG. 21, in the setting processing of Embodiment 3, the setting unit 66 executes steps S202 to S204. The setting unit 66 determines whether the occupant has selected the depth line rotation mode (S220). When the driver aligns the target parking frame 90 with a corner of the division lines 94 on the road surface and operates the frame rotation mode button 86b, the setting unit 66 determines that the frame rotation mode has been selected (S220: Yes), and executes step S222 and subsequent steps. In addition, the setting unit 66 also executes step S222 and subsequent steps even when the frame rotation mode has already been selected.

When the occupant has not selected the frame rotation mode (S220: No), the setting unit 66 determines whether the occupant has selected the depth line rotation mode (S206). The setting unit 66 repeats step S202 and subsequent steps when the occupant has not selected the depth line rotation mode (S206: No). When the driver aligns the target parking frame 90 with a corner of the division lines 94 on the road surface and operates the depth line rotation mode button 86b, the setting unit 66 determines that the depth line rotation mode has been selected (S206: Yes), and executes step S208 and subsequent steps. In addition, the setting unit 66 also executes step S208 and subsequent steps even when the depth line rotation mode has already been selected.

The setting unit 66 terminates the setting processing when any one of steps S214 and S228 is executed.

As described above, the driving support device 60 of Embodiment 3 executes the rotation mode in response to the selection of the depth line rotation mode or the frame rotation mode acquired from the occupant. Thus, the driving support device 60 is capable of appropriately providing an environment in which the target parking direction is capable of being set more appropriately in response to the occupant's selection of the rotation mode.

### Embodiment 4

Embodiment 4 in which the setting method of the target parking direction is different will be described.

The setting unit 66 of Embodiment 4 receives the setting of the target parking direction by steering in one direction of the steering unit 30, and invalidates steering in the other direction of the steering unit 30. Specifically, the setting unit 66 sets the target parking direction based on the steering of the steering unit 30 opposite to the target parking direction. Meanwhile, the setting unit 66 invalidates the steering of the steering unit 30 on the target parking direction side and does not adopt it for setting the target parking direction. In this case, the setting unit 66 may cause the depth line 90c to be inclined relative to the direction lines 90b in the initial state of the setting image 84. Specifically, the setting unit 66 may arrange the direction line 90b side ends of the depth lines 90c in front of the towing vehicle 10 rather than the deep side ends.

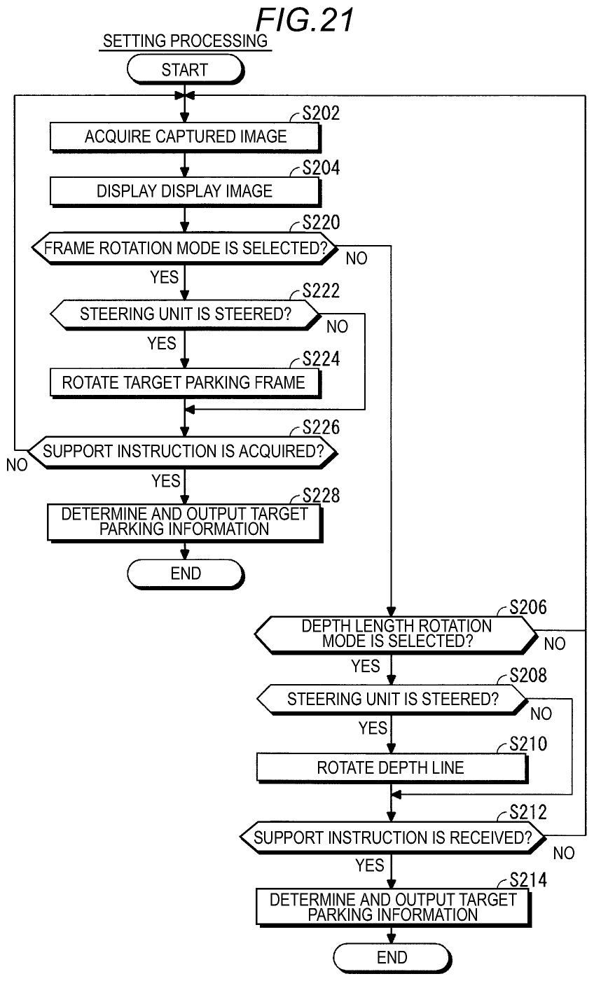

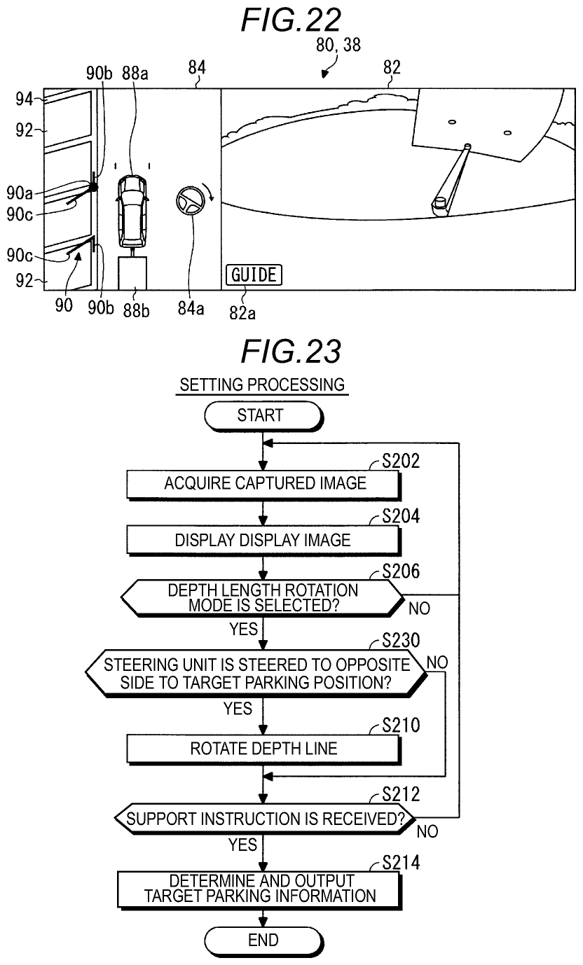

FIG. 22 is a view illustrating an exemplary setting image 84 in an initial state in Embodiment 4. As illustrated in FIG. 22, the setting unit 66 superimposes a target parking frame 90 including depth lines 90c inclined relative to the direction lines 90b on the setting image 84. Specifically, the setting unit 66 arranges the direction line 90b side ends of the depth lines 90c in front of the deep side ends. In this state, when the driver steers the steering unit 30 to the side opposite to the target parking position on the left side (here, rightward rotation), the setting unit 66 rotates the depth lines 90c about the direction line 90b side ends of the depth lines 90c as respective rotation centers. Meanwhile, the setting unit 66 does not rotate the depth lines 90c even if the steering unit 30 is steered to the target parking position side. The setting unit 66 sets the target parking direction by the steering of the steering unit 30 opposite to the target parking direction.

FIG. 23 is a flowchart of a setting processing of Embodiment 4 performed by the setting unit 60. The steps of the same contents as the steps of the setting processing of the embodiments described above will be given the same step numbers and a description thereof will be omitted.

As illustrated in FIG. 23, the setting unit 66 executes steps S202 to S206. When the rotation mode is shifted to the depth line rotation mode by the occupant's selection (S206: Yes), the setting unit 66 determines whether the driver has steered the steering unit 30 to the side opposite to the target parking position (S230). When it is determined that the driver has steered the steering unit 30 to the side opposite to the target parking position (S230: Yes), the setting unit 66 rotates the depth lines 90c depending on the steering angle of the steering unit 30 (S210), and executes the step S212 and subsequent steps.

Meanwhile, when it is determined that the driver has not steered the steering unit 30 to the side opposite to the target parking position (S230: No), the setting unit 66 executes the step S212 and subsequent steps without rotating the depth lines 90c. As mentioned herein, the description that the driver has not steered the steering unit 30 to the side opposite to the target parking position includes the state in which the steering unit 30 is not steered and the state in which the steering unit 30 is steered to the target parking position.

Thereafter, when the setting unit 66 executes the step S214, the setting processing is terminated.

As described above, the operation support device 60 of Embodiment 4 sets the target parking direction through steering of the steering unit 30 to the side opposite to the target parking position. Thus, the operation support device 60 may omit an unnecessary operation for a general parking frame 92. More specifically, with respect to the parking frame 92 in which the direction line 90b side ends of the depth lines 90c are frequently located in front of the deep side ends thereof or the direction line 90b side ends of the depth lines 90c are frequently located at the same position as the deep side ends thereof, the driving support device 60 may omit unnecessary operations.

### Embodiment 5

Embodiment 5 in which the towing vehicle 10 is parked in a right parking frame 92 will be described. Embodiment 5 will be described as a modification of Embodiment 3, but may be applied to other embodiments.

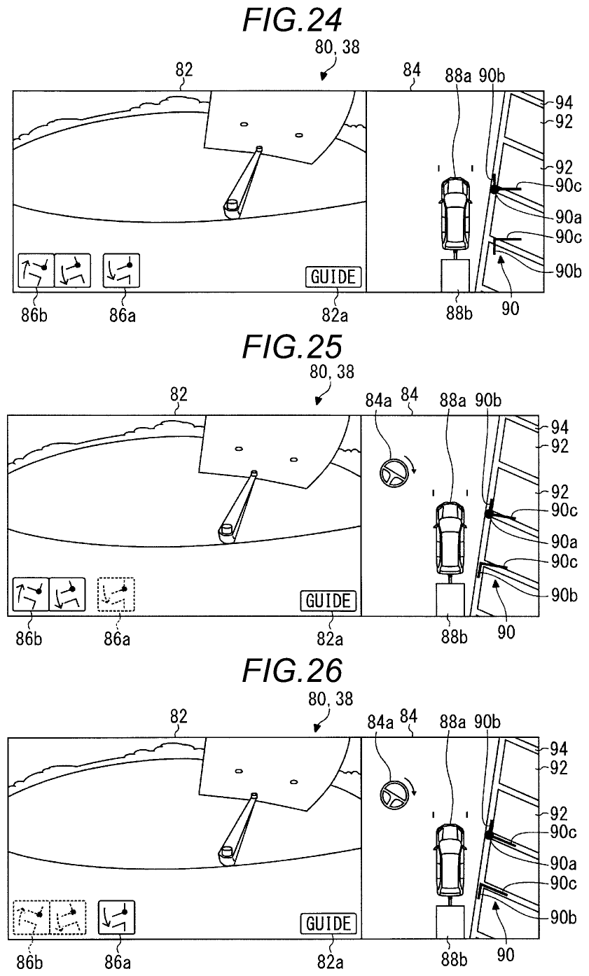

FIG. 24 is a view illustrating an exemplary display image 80 in which a target parking position is set in the setting processing of Embodiment 5. As illustrated in FIG. 24, the setting unit 66 of Embodiment 5 arranges the target parking frame 90 on the right side on the vehicle image 88a of the towing vehicle 10 in the setting image 84. The target parking frame 90 includes a reference point 90a, direction lines 90b, and depth lines 90c extending to the right from the direction lines 90b. When the occupant aligns the reference point 90a of the target parking frame 90 with a corner of the division lines 94 and operates the frame rotation mode button 86b, the setting unit 66 shifts to the frame rotation mode.

FIG. 25 is a view illustrating an exemplary display image 80 including a setting image 84 in which a target parking direction is set in a frame rotation mode according to Embodiment 5. As illustrated in FIG. 25, when the occupant steers the steering unit 30 to the right, the setting unit 66 rotates the entire target parking frame 90 about the reference point 90a as the rotation center depending on the steering angle of the steering unit 30. When the occupant aligns the direction lines 90b with the division lines 94 and operates the depth line rotation mode button 86a, the setting unit 66 shifts to the depth line rotation mode.

FIG. 26 is a view illustrating an exemplary display image 80 including a setting image 84 in which a target parking direction is set in a depth line rotation mode according to Embodiment 5. As illustrated in FIG. 26, when the occupant steers the steering unit 30 to the right, the setting unit 66 rotates the depth lines 90c about the direction line 90b side ends of the depth lines 90c as respective rotation centers depending on the steering angle of the steering unit 30. When the occupant aligns the depth lines 90c with the division lines 94 and operates the guide button 82a, the setting unit 66 outputs target parking information including the target parking position and the target parking direction to the support unit 68, and terminates the setting processing.

### Embodiment 6

Embodiment 6 will be described in which the support unit 68 outputs one or more of steering information and stop information related to the steering of the steering unit 30 as an image or sound and causes the passenger to manually perform steering. That is, Embodiment 6 may be applied to the towing vehicle 10 in which an occupant steers the steering unit 30.

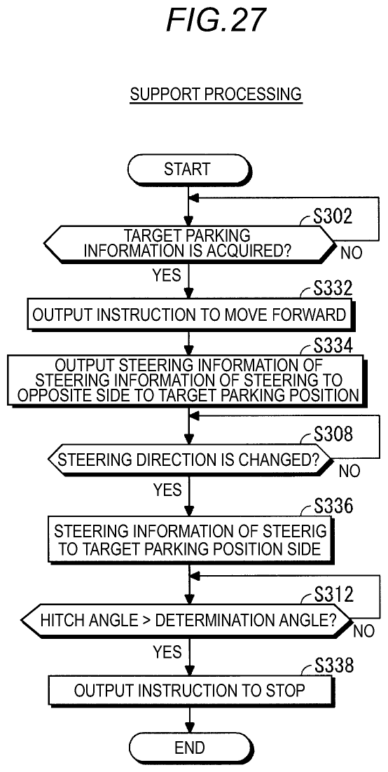

FIG. 27 is a flowchart of a support processing of Embodiment 6 performed by the support unit 68. As illustrated in FIG. 27, the support unit 68 determines whether the target parking information has been acquired from the setting unit 66 (S302). The support unit 68 is in a standby state until the target parking information is acquired (S302: No). When the support unit 68 acquires the target parking information (S302: Yes), the support unit 68 causes the display unit 38 or the sound output unit 40 to output an image or sound for moving forward the towing vehicle 10 (S332). The support unit 68 causes the display unit 38 or the sound output unit 40 to output steering information for steering the steering unit 30 so as to steer to the side opposite to the target parking position with the start of the forward movement (S334).

The support unit 68 determines whether to change the steering direction (S308). The support unit 68 continues forward movement and steering in the same direction until it is determined that the steering direction is to be changed (S308: No). When it is determined that the steering direction is to be changed based on, for example, the hitch angle or the distance from the target parking position to the towing vehicle 10 (S308: Yes), the support unit 68 causes the display part 38 or the sound output unit 40 to output steering information for causing steering unit 30 to steer to the target parking position side by an image or sound (S336).

The support unit 68 determines whether the hitch angle is larger than the determination angle (S312). The support unit 68 is in the standby state until the hitch angle becomes larger than the determination angle (S312: No). When it is determined that the hitch angle becomes larger than the determination angle (S312: Yes), the support unit 68 causes the display unit 38 or the sound output unit 40 to output an instruction to stop the towing vehicle 10 by an image or sound (S338). The support unit 68 may cause the steering information after the start of the backward movement to be output by an image or sound.

The driving support device 60 of Embodiment 6 outputs an instruction to steer to the side opposite to the target parking position by an image or sound during the forward movement of the towing vehicle 10, and then outputs an instruction to steer to the target parking position side. Thus, the driving support device 60 is capable of properly parking the towing vehicle 10, which is manually driven, even in a narrow space around the target parking position.

For example, the functions, connection relationships, number, and arrangement of the configurations of the respective embodiments described above may be appropriately changed or omitted within the scope of the disclosure and the scope equivalent to the scope of the disclosure. Respective embodiments may be combined with each other as appropriate. The order of respective steps in each embodiment may be changed as appropriate.

Although the setting unit 66 of the above-described embodiments set the target parking position and the target parking direction depending on the position of the towing vehicle 10 and in response to an input from the occupant, the setting of the target parking position and the target parking direction is not limited to the method. For example, the setting unit 66 may automatically set the target parking position and the target parking direction based on, for example, a captured image.

In the above-described embodiments, an example in which the setting unit 66 sets a target parking direction depending on the steering angle of the steering unit 30 has been described, the setting method of the target parking direction is not limited thereto. For example, the setting unit 66 may set the target parking direction depending on the time when the steering unit 30 is steered. For example, the setting unit 66 may set the target parking direction depending on the product of the time during which the steering unit 30 is steered in any direction and a predetermined unit angle. Specifically, when the steering unit 30 is steered to the right for 5 seconds, the setting unit 66 may set the target parking direction to a direction rotated to the right from the reference direction by 5× unit angle. In this case, the setting unit 66 may change the rotational speed of the target parking frame 90 or the depth lines 90c depending on the steering angle of the steering unit 30. Specifically, the setting unit 66 may increase the rotational speed of the target parking frame 90 or the depth lines 90c as the steering angle of the steering unit 30 is increased.

In the above-described embodiments, an example in which the driver sets the target parking position by causing the towing vehicle 10 to travel so as to align the reference point 90a of the target parking frame 90 with a corner of the dividing lines 94 on the road surface has been described. However, the method of setting the target parking position is not limited thereto. For example, the setting unit 66 may extract the division lines 94 from a captured image captured by the imaging units 14 and automatically set the target parking position. In addition, the setting unit 66 may automatically set the target parking position depending on the position of the target parking frame 90 on the setting image 84 by moving the target parking frame 90 on the setting image 84 based on the input of the occupant which is received from the operation input unit 42.

The setting unit 66 of the above-described embodiments sets the position of the steering unit 30 at the time of shifting to the rotation mode as a reference angle, and sets the target parking direction by setting an angle rotated from the reference angle as the steering angle. The definition of the steering angle is not limited thereto. For example, the setting unit 66 may set the neutral state of the steering unit 30, that is, the reference state in which the towing vehicle 10 travels straight as the reference angle. In addition, when the steering unit 30 is in the vicinity of the maximum steering angle or the maximum steering angle when shifting to the rotation mode, the setting unit 66 may set the reference angle to a position offset to the neutral position side from the position of the steering unit 30 at the time of shifting. In addition, when receiving an instruction to shift to the rotation mode, in the case where the steering unit 30 is at the maximum steering angle or near the maximum steering angle, the setting unit 66 may output by an image or sound that it is impossible to shift to the rotation mode.

In the embodiments described above, an example in which the support unit 68 calculates the hitch angle from the images captured by the imaging units 14 in the determination of switching from forward movement to backward movement has been described. However, the method for calculating the hitch angle is not limited thereto. For example, the support unit 68 may calculate the hitch angle based on the distance between the towing vehicle 10 and the towed vehicle 20 which is detected by, for example, a distance measurement sensor provided on the rear portion of the towing vehicle 10. In addition, the support unit 68 may determine whether the hitch angle has become the determination angle based on, for example, the steering angle of the steering unit 30 and the traveling distance of the towing vehicle 10 without calculating the hitch angle.

Although the support unit 68 of the above-described embodiment determines switching from forward movement to backward movement based on the hitch angle, the method of determining switching is not limited to the method based on the hitch angle. For example, the support unit 68 may repeatedly calculate the parking path at the time of backward movement while moving forward the towing vehicle 10, and when it is determined that it is possible to park at the target parking position in the target parking direction when the steering unit 30 is shifted from the neutral state to the backward movement state, the support unit 68 may determine to switch from forward movement to backward movement. In addition, the support unit 68 may repeatedly calculate the parking path at the time of backward movement while moving forward the towing vehicle 10, and when it is determined that it is possible to park at the target parking position in the target parking direction when the steering unit 30 is steered to the target parking position side so as to move backward, the support unit 68 may determine to switch from forward movement to backward movement.

In the above-described embodiments, an example in which the setting unit 66 sets a target parking direction through the steering of the steering unit 30 has been described, the setting method of the target parking direction is not limited thereto. For example, the setting unit 66 may set the target parking direction based on inputs from a direction indicator and an operation input unit 42 such as a touch panel or a touch pad.

A driving support device according to an aspect of this disclosure includes: a setting unit configured to set a target parking position; and a support unit configured to: steer, during forward movement of a towing vehicle, a steering unit to a side opposite to the target parking position in a left-right direction of the towing vehicle; then output steering information for steering the steering unit toward the target parking position; and output stop information for stopping the towing vehicle after a connection state between the towing vehicle and a towed vehicle which is towed by the towing vehicle is inclined toward the target parking position.

Thus, the driving support device according to the aspect of this disclosure is capable of bending the towing vehicle and the towed vehicle so as to protrude to a side opposite to the target parking position in a plan view by steering to the side opposite to the target parking position during forward movement and then steering to the target parking position side. As described above, since the driving support device bends the towing vehicle and the towed vehicle to protrude to the side opposite to the target parking position and then moves backward the towing vehicle and the towed vehicle to the target parking position side, it is possible to appropriately park the towing vehicle and the towed vehicle even if the space around the target parking position is narrow.

In the driving support device according to the aspect of this disclosure, the support unit may control the steering unit by outputting the steering information.

Thus, the driving support device according to the aspect of this disclosure is capable of appropriately parking the towing vehicle and the towed vehicle while reducing the work of a driver.

In the driving support device according to the aspect of this disclosure, the support unit may cause at least one of the steering information and the stop information to be output as an image or sound.

Thus, the driving support device according to the aspect of this disclosure is capable of appropriately parking the towing vehicle and the towed vehicle even if the towing vehicle is manually driven.

In the driving support device according to the aspect of this disclosure, the support unit may determine whether to switch the towing vehicle from forward movement to backward movement depending on a hitch angle which is an angle between the towing vehicle and the towed vehicle.

Thus, the driving support device according to the aspect of this disclosure is capable of appropriately parking the towing vehicle and the towed vehicle since it is possible to appropriately bend the towing vehicle and towed vehicle and then initiate backward movement.

In the driving support device according to the aspect of this disclosure, in the state of causing a display unit to display a setting image including a target parking frame for setting the target parking position, the setting unit may receive inclination of the target parking frame, and may set a target parking direction, which is a direction of the towing vehicle at the target parking position, based on the received inclination.

Thus, the driving support device according to the aspect of this disclosure is capable of causing an occupant to visually recognize a relationship between the towing vehicle or the division lines on a road surface and the target parking frame so as to adjust the target parking direction.

In the driving support device according to the aspect of this disclosure, the setting unit may set the inclination of the target parking frame rotated in response to the steering of the steering unit as the target steering direction.

Thus, the driving support device according to the aspect of this disclosure is capable of causing the occupant to adjust the target parking direction in an intuitively easy-to-understand manner.

In the driving support device according to the aspect of this disclosure, the setting unit may set the target parking direction by rotating a pair of opposite depth lines included in the target parking frame on the setting image about one ends of the depth lines as respective rotation centers.

Thus, the driving support device according to the aspect of this disclosure is capable of appropriately setting the target parking direction even when the parking frame is inclined with respect to the road of a parking lot, and parking the towing vehicle according to the parking frame.

In the driving support device according to the aspect of this disclosure, the setting unit may set the target parking direction by rotating the target parking frame about a first coordinate existing on the setting image.

Thus, the driving support device according to the aspect of this disclosure is capable of appropriately setting the target parking frame for the towing vehicle.

In the driving support device according to the aspect of this disclosure, the setting unit may set the target parking direction by receiving, from an occupant, selection of any one of a depth line rotation mode of setting the target parking direction by rotating a pair of opposite depth lines included in the target parking frame about one ends of the depth lines as respective rotation centers on the setting image and a frame rotation mode of setting the target parking direction by rotating the target parking frame about a first coordinate existing on the setting image.

Thus, the driving support device according to the aspect of this disclosure is capable of appropriately providing an environment in which the target parking direction is capable of being set more appropriately set in response to the occupant's selection of the rotation mode.

In the driving support device according to the aspect of this disclosure, the setting unit may set the target parking direction based on steering of the steering unit to the side opposite to the target parking position.

Thus, the driving support device according to the aspect of this disclosure is capable of omitting an unnecessary operation for a general parking frame.

In the driving support device according to the aspect of this disclosure, when the target parking direction is set by the setting unit, the support unit may output the stop information for stopping the towing vehicle when a hitch angle, which is an angle between the towing vehicle and the towed vehicle corresponding to the target parking direction, is reached.

Thus, the driving support device according to the aspect of this disclosure is capable of appropriately stopping the towing vehicle to correspond to the target parking direction.

In the driving support device according to the aspect of this disclosure, the support unit may also output the stop information for stopping the towing vehicle after a rear end of the towed vehicle advances from the target parking position existing on a side in a left-right direction of the towed vehicle.

Thus, the driving support device according to the aspect of this disclosure is capable of stopping the towing vehicle at an appropriate position corresponding to the target parking position.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A driving support device comprising:
a setting unit configured to set a target parking position; and
a support unit configured to: steer, during forward movement of a towing vehicle, a steering unit to a side opposite to the target parking position in a left-right direction of the towing vehicle; then output steering information for steering the steering unit toward the target parking position; and output stop information for stopping the towing vehicle after a connection state between the towing vehicle and a towed vehicle which is towed by the towing vehicle is inclined toward the target parking position.

2. The driving support device according to claim 1, wherein the support unit controls the steering unit by outputting the steering information.

3. The driving support device according to claim 1, wherein the support unit causes at least one of the steering information and the stop information to be output as an image or sound.

4. The driving support device according to claim 1, wherein the support unit determines whether to switch the towing vehicle from forward movement to backward movement depending on a hitch angle which is an angle between the towing vehicle and the towed vehicle.

5. The driving support device according to claim 1, wherein in a state of causing a display unit to display a setting image including a target parking frame for setting the target parking position, the setting unit receives inclination of the target parking frame, and sets a target parking direction, which is a direction of the towing vehicle at the target parking position, based on the received inclination.

6. The driving support device according to claim 5, wherein the setting unit sets the inclination of the target parking frame rotated in response to the steering of the steering unit as the target steering direction.

7. The driving support device according to claim 5, wherein the setting unit sets the target parking direction by rotating a pair of opposite depth lines included in the target parking frame on the setting image about one ends of the depth lines as respective rotation centers.

8. The driving support device according to claim 5, wherein the setting unit sets the target parking direction by rotating the target parking frame about a first coordinate existing on the setting image.

9. The driving support device according to claim 5, wherein the setting unit sets the target parking direction by receiving, from an occupant, selection of any one of a depth line rotation mode of setting the target parking direction by rotating a pair of opposite depth lines included in the target parking frame about one ends of the depth lines as respective rotation centers on the setting image and a frame rotation mode of setting the target parking direction by rotating the target parking frame about a first coordinate existing on the setting image.

10. The driving support device according to claim 6, wherein the setting unit sets the target parking direction based on steering of the steering unit to the side opposite to the target parking position.

11. The driving support device according to claim 5, wherein, when the target parking direction is set by the setting unit, the support unit outputs the stop information for stopping the towing vehicle when a hitch angle, which is an angle between the towing vehicle and the towed vehicle corresponding to the target parking direction, is reached.

12. The driving support device according to claim 1, wherein the support unit further outputs the stop information for stopping the towing vehicle after a rear end of the towed vehicle advances from the target parking position existing on a side in a left-right direction of the towed vehicle.
